(19) United States
(12) Patent Application Publication
(10) Pub. No.: US 2022/0371592 A1
(43) Pub. Date: Nov. 24, 2022

(54) DEVICE AND METHOD FOR CONTROLLING DRIVING MODE OF VEHICLE

(71) Applicants: HYUNDAI MOTOR COMPANY, Seoul (KR); Kia Corporation, Seoul (KR)

(72) Inventors: Min Jae Chai, Gwangmyeong-si (KR); Byeong Wook Jeon, Seoul (KR); Yong Uk Shin, Seongnam-si (KR); Dong Hoon Jeong, Hwaseong-si (KR)

(73) Assignees: HYUNDAI MOTOR COMPANY, Seoul (KR); Kia Corporation, Seoul (KR)

(21) Appl. No.: 17/498,043

(22) Filed: Oct. 11, 2021

(30) Foreign Application Priority Data
May 21, 2021 (KR) 10-2021-0065705

(51) Int. Cl. B60W 30/182; B60W 50/14; B60W 50/12; B60W 50/08

(52) U.S. Cl. CPC B60W 30/182; B60W 50/14; B60W 50/12; B60W 50/082; B60W 2556/50; B60W 2552/05; B60W 2552/15; B60W 2540/215

(57) ABSTRACT

Disclosed are a device and a method for controlling a driving mode of a vehicle. The device includes a sensor for collecting information about an access road to a controlled-access highway, and a controller which determines a switching point on the access road at which the driving mode of the vehicle is switched to a sport mode, based on the information about the access road to the controlled-access highway, and switches the driving mode of the vehicle to the sport mode when the vehicle reaches the switching point on the access road. Thus, the vehicle accesses the controlled-access highway naturally without interfering with flow of other vehicles.

### CROSS-REFERENCE TO RELATED APPLICATION

This application claims the benefit of priority to Korean Patent Application No. 10-2021-0065705, filed in the Korean Intellectual Property Office on May 21, 2021, the entire contents of which are incorporated herein by reference.

### TECHNICAL FIELD

The present disclosure relates to a technique for determining a point at which a vehicle's driving mode should be switched to a sport mode (an accelerated mode), on a road (hereinafter, access road) for access to a controlled-access highway.

### BACKGROUND

Typically, a vehicle runs according to a general shift pattern and an engine torque response setting mode. Further, when the vehicle drives in an accelerated mode, for example, in the controlled-access highway, a driver should rapidly accelerate the vehicle to match a speed of a vehicle of interest with speeds of other vehicles running on the controlled-access highway. However, despite the driver's rapid acceleration operation, the vehicle may not rapidly respond to the driver's acceleration operation.

This is because driving in a normal mode or driving in an ECO mode does not take into account a rapid acceleration condition. In order to overcome this situation, the driver presses a switching button to switch a driving mode of the vehicle to a sport mode every time the vehicle accesses the controlled-access highway.

After all, there is a difficulty in that every time the vehicle accesses the controlled-access highway, the driver has to operate the button that switches the driving mode to the sport mode while driving the vehicle. Further, there is an inconvenience in that after the vehicle has accessed the controlled-access highway, and when the vehicle reaches a certain speed, the driver has to return the driving mode to the normal mode again.

A conventional technology for controlling the driving mode of the vehicle discloses only a configuration in which when the vehicle is predicted to access the controlled-access highway, the driving mode of the vehicle is changed. The conventional technology fails to consider a point at which the driving mode should be changed. Thus, acceleration performance of the vehicle cannot be maximized.

Matters described in this “Background” section are written to improve understanding of the background of the present disclosure, and may include matters that are not already known to those of ordinary skill in the art to which this technology belongs.

### SUMMARY

The present disclosure has been made to solve the above-mentioned problems occurring in the prior art while advantages achieved by the prior art are maintained intact.

An aspect of the present disclosure provides a device and a method for controlling a driving mode of the vehicle that determines a point (a switching point) at which the driving mode of the vehicle is switched to a sport mode (accelerated mode), based on information about an access road to a controlled-access highway, and switches the driving mode of the vehicle to the sport mode when the vehicle reaches the point on the access road, such that the vehicle may access the controlled-access highway naturally without interfering with flow of other vehicles driving along the controlled-access highway while maximizing the acceleration performance of the vehicle.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for controlling a driving mode of a vehicle includes a sensor for collecting information about an access road to a controlled-access highway, and a controller which determines a switching point on the access road at which the driving mode of the vehicle is switched to a sport mode, based on the information about the access road to the controlled-access highway, and switches the driving mode of the vehicle to the sport mode when the vehicle reaches the switching point on the access road.

In one embodiment, the device may further include storage for storing therein information about a shortest point as the switching point on the access road to the controlled-access highway.

In one embodiment, the information about the access road to the controlled-access highway may include at least one of inclination information of the access road, or tollgate position information on the access road.

In one embodiment, when each of a distance between an inclination start point on the access road and the controlled-access highway, and a distance between a tollgate point on the access road and the controlled-access highway is larger than a distance between the shortest point and the controlled-access highway, the controller may determine, as the switching point, one of the inclination start point and the tollgate point closer to the shortest point.

In one embodiment, when each of a distance between an inclination start point on the access road and the controlled-access highway, and a distance between a tollgate point on the access road and the controlled-access highway is smaller than a distance between the shortest point and the controlled-access highway, the controller may determine the shortest point as the switching point.

In one embodiment, the information about the access road to the controlled-access highway may include at least one of curvature information of the access road, or tollgate position information on the access road.

In one embodiment, when each of a distance between a curved-road ending point on the access road and the controlled-access highway, and a distance between a tollgate point on the access road and the controlled-access highway is larger than a distance between the shortest point and the controlled-access highway, the controller may determine, as the switching point, one of the curved-road ending point and the tollgate point closer to the shortest point.

In one embodiment, when each of a distance between a curved-road ending point on the access road and the controlled-access highway, and a distance between a tollgate point on the access road and the controlled-access highway is smaller than a distance between the shortest point and the controlled-access highway, the controller may determine the shortest point as the switching point.

In one embodiment, the device may further include a display. When the vehicle's driving mode is switched to the sport mode, the display may be configured to display information about the switching of the driving mode to the sport mode.

According to an aspect of the present disclosure, a method for controlling a driving mode of a vehicle includes collecting, by a sensor, information about an access road to a controlled-access highway, determining, by a controller, a switching point on the access road at which the driving mode of the vehicle is switched to a sport mode, based on the information about the access road, and switching, by the controller, the driving mode of the vehicle to the sport mode when the vehicle reaches the switching point on the access road to the controlled-access highway.

In one embodiment, the method may further include storing, by storage, information about a shortest point as the switching point on the access road to the controlled-access highway.

In one embodiment, the information about the access road to the controlled-access highway may include at least one of inclination information of the access road, or tollgate position information on the access road.

In one embodiment, the determining of the switching point may include: when each of a distance between an inclination start point on the access road and the controlled-access highway, and a distance between a tollgate point on the access road and the controlled-access highway is larger than a distance between the shortest point and the controlled-access highway, determining, as the switching point, one of the inclination start point and the tollgate point closer to the shortest point.

In one embodiment, the determining of the switching point may include: when each of a distance between an inclination start point on the access road and the controlled-access highway, and a distance between a tollgate point on the access road and the controlled-access highway is smaller than a distance between the shortest point and the controlled-access highway, determining the shortest point as the switching point.

In one embodiment, the information about the access road to the controlled-access highway may include at least one of curvature information of the access road, or tollgate position information on the access road.

In one embodiment, the determining of the switching point may include: when each of a distance between a curved-road ending point on the access road and the controlled-access highway, and a distance between a tollgate point on the access road and the controlled-access highway is larger than a distance between the shortest point and the controlled-access highway, determining, as the switching point, one of the curved-road ending point and the tollgate point closer to the shortest point.

In one embodiment, the determining of the switching point may include: when each of a distance between a curved-road ending point on the access road and the controlled-access highway, and a distance between a tollgate point on the access road and the controlled-access highway is smaller than a distance between the shortest point and the controlled-access highway, determining the shortest point as the switching point.

In one embodiment, the method may further include displaying, by a display, information about the switching of the vehicle's driving mode to the sport mode.

### BRIEF DESCRIPTION OF THE DRAWINGS

The above and other objects, features and advantages of the present disclosure will be more apparent from the following detailed description taken in conjunction with the accompanying drawings:

FIG. 1 is a configuration diagram of a device for controlling a driving mode of a vehicle according to one embodiment of the present disclosure;

FIG. 2 is a detailed configuration diagram of a sensor provided in a device for controlling a driving mode of a vehicle according to one embodiment of the present disclosure;

FIG. 3 is an example diagram showing a process in which a controller provided in the device for controlling the driving mode of the vehicle according to one embodiment of the present disclosure determines a point on an access road to a controlled-access highway at which the driving mode of the vehicle is switched to a sport mode;

FIG. 4 is another example diagram showing a process in which a controller provided in the device for controlling the driving mode of the vehicle according to one embodiment of the present disclosure determines a point on an access road to a controlled-access highway at which the driving mode of the vehicle is switched to a sport mode;

FIG. 5 is a flow diagram for a method for controlling a driving mode of a vehicle according to one embodiment of the present disclosure; and

FIG. 6 is a block diagram showing a computing system for executing a method for controlling a driving mode of a vehicle according to one embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

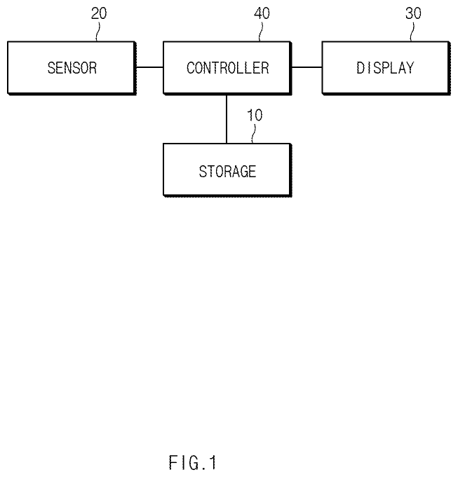

FIG. 1 is a configuration diagram of a device for controlling a driving mode of a vehicle according to one embodiment of the present disclosure.

As shown in FIG. 1, the device for controlling a driving mode of a vehicle according to one embodiment of the present disclosure may include storage 10, a sensor 20, a display 30, and a controller 40. In this connection, the components may be combined with each other into one component, and some components may be omitted, depending on a manner of implementing the device for controlling a driving mode of a vehicle according to one embodiment of the present disclosure.

Regarding each of the components, first, the storage 10 may store therein various logics and algorithms and programs required in a process of determining a point at which the vehicle's driving mode is switched to a sport mode (accelerated mode), based on information about an access road to a controlled-access highway, and switching the driving mode of the vehicle to the sport mode when the vehicle reaches the point on the access road.

The storage 10 may store therein information (position information) about the shortest point on the access road to the controlled-access highway at which the driving mode of the vehicle is switched to the sport mode. In this connection, the shortest point is a fixed point on the access road to the controlled-access highway, and means a point at which the vehicle's driving mode must be switched to the sport mode.

The storage 10 may include at least one type storage medium selected from a flash memory, a hard disk, a micro type memory, a card type memory such as a SD card (Secure Digital Card) or an XD card (eXtream Digital Card), RAM (Random Access Memory), SRAM (Static RAM), ROM (Read-Only Memory), PROM (Programmable ROM), EEPROM (Electrically Erasable PROM), a magnetic RAM (MRAM), a magnetic disk, and an optical disc.

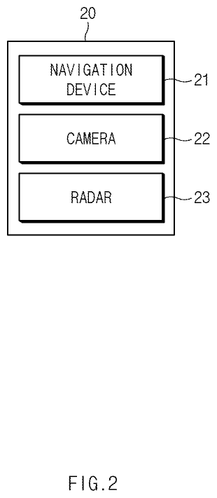

The sensor 20 may refer to a generic term for various sensors provided in the vehicle, and may include sensors as shown in FIG. 2 in one example.

FIG. 2 is a detailed configuration diagram of a sensor provided in a device for controlling a driving mode of a vehicle according to one embodiment of the present disclosure.

As shown in FIG. 2, the sensor 20 provided in the device for controlling the driving mode of the vehicle according to one embodiment of the present disclosure may include a navigation device 21, a camera 22, and a radar 23.

The navigation device 21 may collect controlled-access highway information, information about an access road to a controlled-access highway, traffic information, and the like. In this case, the information about the access road to the controlled-access highway may include type information of the access road, curvature information of the access road, inclination information of the access road, tollgate position information on the access road, and the like.

The navigation device 21 may be equipped with a GPS receiver and may collect current position information of the vehicle.

The camera 22 may photograph front, rear, and side images of the vehicle.

The radar 23 may detect an obstacle (other vehicles) located in front, rear, and side of the vehicle, and measure a distance between the vehicle and the obstacle.

In one example, the display 30 may display a current driving mode of the vehicle. In particular, when the vehicle's driving mode is switched to the sport mode, the display 30 may inform the driver of such switching.

The controller 40 may perform overall control so that each of the components may perform a function thereof normally. The controller 40 may be implemented in a form of hardware, or may be implemented in a form of software, or may be implemented in a form of a combination of hardware and software. Preferably, the controller 40 may be implemented as a microprocessor or a processor, but is not limited thereto.

In particular, the controller 40 may perform various controls in the process of determining a switching point at which the vehicle's driving mode is switched to the sport mode (accelerated mode), based on the information about the access road to the controlled-access highway, and of switching the driving mode of the vehicle to the sport mode when the vehicle reaches the switching point on the access road.

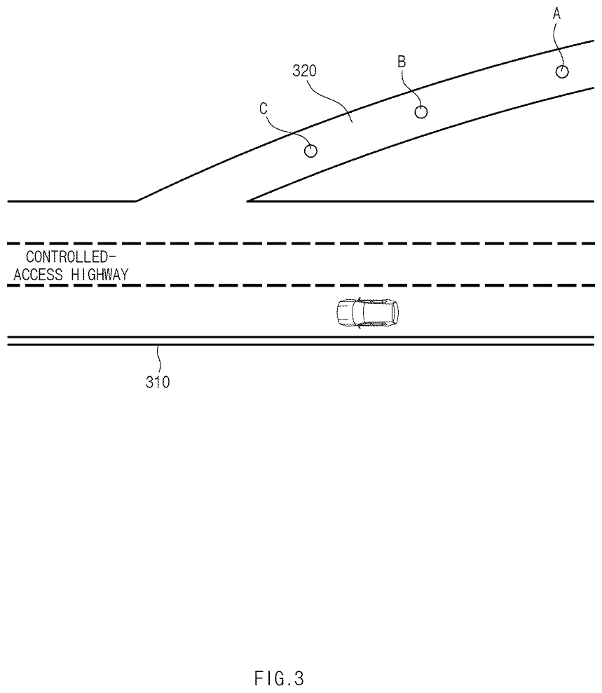

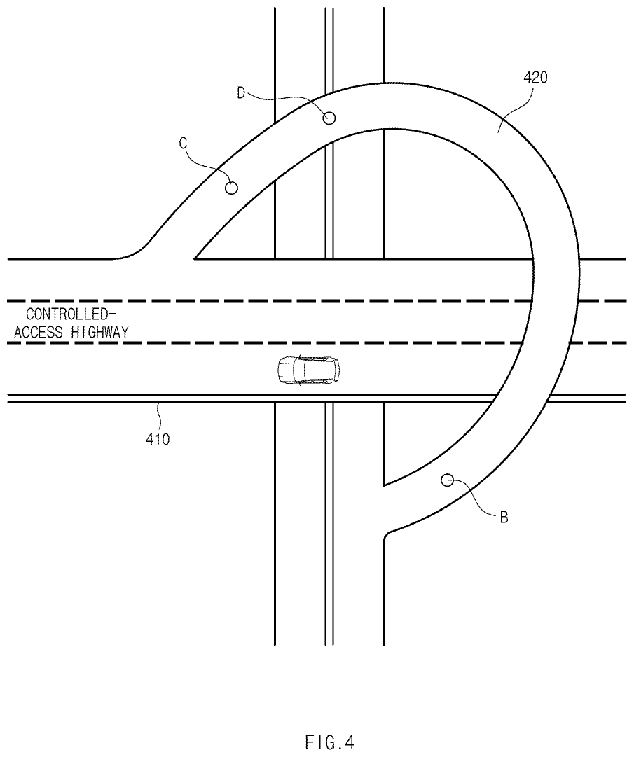

Hereinafter, an operation of the controller 40 will be described in detail with reference to FIG. 3 and FIG. 4.

FIG. 3 is an example diagram showing a process in which a controller provided in the device for controlling the driving mode of the vehicle according to one embodiment of the present disclosure determines a point on an access road to a controlled-access highway at which the driving mode of the vehicle is switched to a sport mode.

In FIG. 3, ‘310’ represents a median strip of a controlled-access highway, ‘320’ represents an access road to a controlled-access highway, a point A indicates a point where an inclination (in one example, upward inclination) starts on the access road 320 to the controlled-access highway, a point B indicates a tollgate, and a point C indicates the shortest point at which the driving mode is switched to the sport mode.

As shown in FIG. 3, when the point A and the point B are located before the point C in a driving direction, that is, a distance from the controlled-access highway to the point A is larger than a distance from the controlled-access highway to the point C, and a distance from the controlled-access highway to the point B is larger than a distance from the controlled-access highway to the point C, the controller 40 may switch the driving mode of the vehicle to the sport mode when the vehicle reaches the point B located closest to the point C.

In another example not shown in the drawings, when the distance from the controlled-access highway to the point A is larger than the distance from the controlled-access highway to the point C, and the distance from the controlled-access highway to the point B is larger than the distance from the controlled-access highway to the point C, and the distance from the controlled-access highway to the point A is smaller than the distance from the controlled-access highway to the point B, the controller 40 may switch the driving mode of the vehicle to the sport mode when the vehicle reaches the point A.

In one example not shown in the drawings, when each of the point A and the point B is located between the point C and the controlled-access highway, the controller 40 may switch the vehicle's driving mode to the sport mode when the vehicle reaches the point C.

FIG. 4 is another example diagram showing a process in which a controller provided in the device for controlling the driving mode of the vehicle according to one embodiment of the present disclosure determines a point on an access road to a controlled-access highway at which the driving mode of the vehicle is switched to a sport mode.

In FIG. 4, ‘410’ represents a median strip of a controlled-access highway, ‘420’ represents an access road to a controlled-access highway, a point B represents a tollgate, a point C represents the shortest point at which the vehicle is switched to sport mode, and a point D represents a point at which a curved road (having a curvature equal to or below a reference value) ends on the access road 420.

As shown in FIG. 4, when the point B and the point D are located before the point C in a driving direction, that is, a distance from the controlled-access highway to the point B is larger than a distance from the controlled-access highway to the point C, and a distance from the controlled-access highway to the point D is larger than a distance from the controlled-access highway to the point C, the controller 40 may switch the driving mode of the vehicle to the sport mode when the vehicle reaches the point D located closest to the C point.

In another example not shown in the drawings, when the distance from the controlled-access highway to the point B is larger than the distance from the controlled-access highway to the point C, the distance from the controlled-access highway to the point D is larger than the distance from the controlled-access highway to the point C, and the distance from the controlled-access highway to the point B is smaller than the distance from the controlled-access highway to the point D, the controller 40 may switch the vehicle's driving mode to the sport mode when the vehicle reaches the point B.

In one example not shown in the drawings, when each of the point B and the point D is located between the point C and the controlled-access highway, the controller 40 may switch the driving mode of the vehicle to the sport mode when the vehicle reaches the point C.

In one example, when the controller plans to switch the driving mode of the vehicle to the sport mode, the controller 40 may determine a traffic flow of the controlled-access highway, based on various information acquired through the sensor 20 and may switch the driving mode of the vehicle to the sport mode when the identified traffic flow is in a non-congested state. In this connection, the driving mode may include a normal driving mode as a general driving mode, an ECO mode as a driving mode in which acceleration performance is reduced compared to the normal mode to improve fuel efficiency, and the sport mode as a driving mode in which acceleration performance is increased compared to the normal mode.

The controller 40 may change the driving mode of the vehicle based on driving propensity of the driver. In this connection, the driver's driving propensity may be determined based on a sportiness level determined in consideration of a vehicle speed or a change in a position of an accelerator pedal. In one example, the driver's driving propensity may include a first propensity with a low sportiness level (hereinafter, mild propensity), a second propensity with a normal sportiness level (hereinafter, average propensity) and a third propensity with a high sportiness level (hereinafter, sporty propensity).

In one example, as shown in Table 1 below, the controller 40 may determine whether to change the driving mode of the vehicle in consideration of the driver's driving propensity and the traffic flow of the controlled-access highway.

TABLE 1

| | | | Driving mode in |
|---|---|---|---|
| | Driving | Traffic flow of | access to |
| Current | propensity of | controlled- | controlled- |
| driving mode | driver | access highway | access highway |
| ECO mode | Mild propensity | Congested | Normal mode |
| | | Non-congested | Sport mode |
| | Average | Congested | Normal mode |
| | propensity | Non-congested | Sport mode |
| | Sporty | Congested | Sport mode |
| | propensity | Non-congested | Sport mode |
| Normal mode | Mild propensity | Congested | Normal mode |
| | | Non-congested | Sport mode |
| | Average | Congested | Sport mode |
| | propensity | Non-congested | Sport mode |
| | Sporty | Congested | Sport mode |
| | propensity | Mon-congested | Sport mode |
| Sport mode | Not related | Not related | Sport mode |

Based on [Table 1], when the current driving mode of the vehicle is the ECO mode, the driving propensity of the driver is the mild propensity or the average propensity, and the traffic flow of the controlled-access highway is in the non-congested state, the controller 40 may switch the ECO mode to the sport mode. In this connection, when the driver's driving propensity is the sporty propensity, the ECO mode may be switched to the sport mode regardless of the traffic flow of the controlled-access highway.

Further, when the vehicle's driving mode is the ECO mode, and the driver's driving propensity is the mild propensity or the average propensity, but the traffic flow of the controlled-access highway is not in the non-congested state, the controller 40 may switch the ECO mode to the normal mode.

Further, when the driving mode of the vehicle is the normal mode, and the driving propensity of the driver is the mild propensity, and the traffic flow of the controlled-access highway is in the non-congested state, the controller 40 may switch the normal mode to the sport mode.

Further, when the vehicle's driving mode is the normal mode, and the driver's driving propensity is the average propensity or the sporty propensity, the controller 40 may switch the driving mode of the vehicle from the normal mode to the sport mode, regardless of the traffic flow of the controlled-access highway.

Further, when the driver's driving propensity is the mild propensity, but the traffic flow is not in the non-congested, the controller 40 may maintain the normal mode.

Further, when the driving mode of the vehicle is the sport mode, the controller 40 may maintain the sport mode regardless of the driver's driving propensity and the traffic flow of the controlled-access highway.

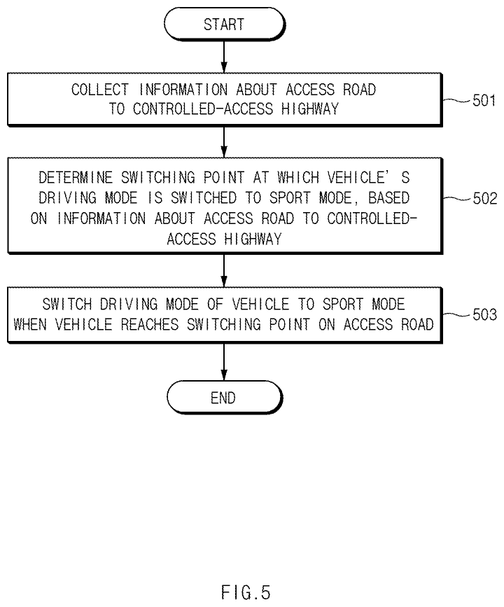

FIG. 5 is a flow diagram for a method for controlling a driving mode of a vehicle according to one embodiment of the present disclosure.

First, the sensor 20 collects information about the access road to the controlled-access highway 501. In this case, the information about the access road to the controlled-access highway may include type information of the access road, curvature information of the access road, inclination information of the access road, tollgate position information on the access road, and the like.

Thereafter, the controller 40 determines a switching point at which the vehicle's driving mode is switched to the sport mode, based on the information about the access road to the controlled-access highway 502. Details thereof are described above with reference to FIG. 3 and FIG. 4.

Thereafter, the controller 40 switches the driving mode of the vehicle to the sport mode (accelerated mode) when the vehicle reaches the switching point on the access road 503.

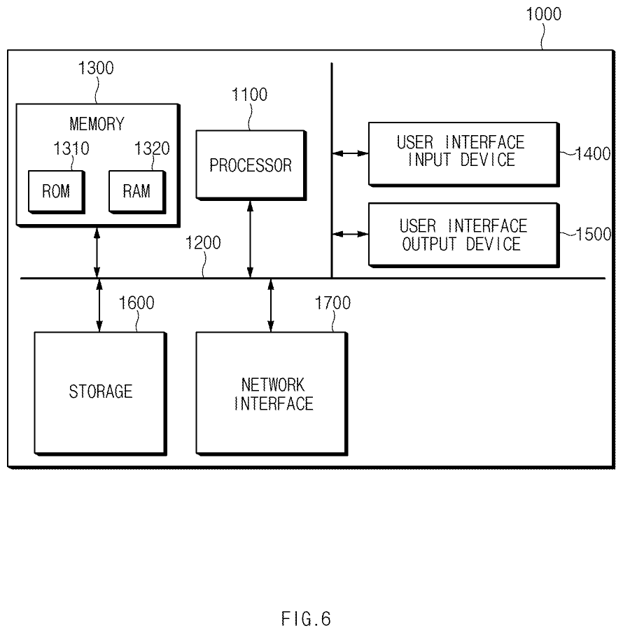

FIG. 6 is a block diagram showing a computing system for executing a method for controlling a driving mode of a vehicle according to one embodiment of the present disclosure.

Referring to FIG. 6, the vehicle driving mode control method according to one embodiment of the present disclosure described above may be implemented using the computing system. A computing system 1000 may include at least one processor 1100, a memory 1300, a user interface input device 1400, a user interface output device 1500, storage 1600, and a network interface 1700 which are connected via a system bus 1200.

The processor 1100 may be a central processing unit (CPU) or a semiconductor device that executes processing related to instructions stored in the memory 1300 and/or the storage 1600. Each of the memory 1300 and the storage 1600 may include various types of volatile or nonvolatile storage media. For example, the memory 1300 may include a ROM (Read Only Memory) 1310 and a RAM (Random Access Memory) 1320.

Accordingly, steps of the method or the algorithm described in connection with the embodiments disclosed herein may be directly implemented in hardware, a software module, or a combination thereof as executed by the processor 1100. The software module may reside on a storage medium (i.e. memory 1300 and/or storage 1600) such as RAM, flash memory, ROM, EPROM, EEPROM, registers, hard disk, SSD solid state drive, removable disk, or CD-ROM. An exemplary storage medium may be coupled to the processor 1100. The processor 1100 is capable of reading information from, and writing information to, the storage medium. Alternatively, the storage medium may be integral with the processor 1100. The processor and the storage medium may reside within an application specific integrated circuit (ASIC). The ASIC may reside within a user terminal. Alternatively, the processor and the storage medium may reside as separate components within the user terminal.

The device and method for controlling the driving mode of the vehicle as described above may determine the point (switching point) at which the driving mode of the vehicle is switched to the sport mode (accelerated mode), based on the information about the access road to the controlled-access highway, and switch the driving mode of the vehicle to the sport mode when the vehicle reaches the point on the access road, such that the vehicle may access the controlled-access highway naturally without interfering with flow of other vehicles driving along the controlled-access highway while maximizing the acceleration performance of the vehicle.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling a driving mode of a vehicle, the device comprising:
a sensor for collecting information about an access road to a controlled-access highway; and
a controller configured to:
determine a switching point on the access road at which the driving mode of the vehicle is switched to a sport mode, based on the information about the access road to the controlled-access highway; and
switch the driving mode of the vehicle to the sport mode when the vehicle reaches the switching point on the access road.

2. The device of claim 1, further comprising a storage for storing therein information about a shortest point as the switching point on the access road to the controlled-access highway.

3. The device of claim 2, wherein the information about the access road to the controlled-access highway includes at least one of inclination information of the access road, or tollgate position information on the access road.

4. The device of claim 3, wherein when each of a distance between an inclination start point on the access road and the controlled-access highway, and a distance between a tollgate point on the access road and the controlled-access highway is larger than a distance between the shortest point and the controlled-access highway, the controller is configured to determine, as the switching point, one of the inclination start point and the tollgate point closer to the shortest point.

5. The device of claim 3, wherein when each of a distance between an inclination start point on the access road and the controlled-access highway, and a distance between a tollgate point on the access road and the controlled-access highway is smaller than a distance between the shortest point and the controlled-access highway, the controller is configured to determine the shortest point as the switching point.

6. The device of claim 2, wherein the information about the access road to the controlled-access highway includes at least one of curvature information of the access road, or tollgate position information on the access road.

7. The device of claim 6, wherein when each of a distance between a curved-road ending point on the access road and the controlled-access highway, and a distance between a tollgate point on the access road and the controlled-access highway is larger than a distance between the shortest point and the controlled-access highway, the controller is configured to determine, as the switching point, one of the curved-road ending point and the tollgate point closer to the shortest point.

8. The device of claim 6, wherein when each of a distance between a curved-road ending point on the access road and the controlled-access highway, and a distance between a tollgate point on the access road and the controlled-access highway is smaller than a distance between the shortest point and the controlled-access highway, the controller is configured to determine the shortest point as the switching point.

9. The device of claim 1, further comprising a display,
wherein when the vehicle's driving mode is switched to the sport mode, the display is configured to display information about the switching of the driving mode to the sport mode.

10. A method for controlling a driving mode of a vehicle, the method comprising:
collecting, by a sensor, information about an access road to a controlled-access highway;
determining, by a controller, a switching point on the access road at which the driving mode of the vehicle is switched to a sport mode, based on the information about the access road; and
switching, by the controller, the driving mode of the vehicle to the sport mode when the vehicle reaches the switching point on the access road to the controlled-access highway.

11. The method of claim 10, further comprising storing, by a storage, information about a shortest point as the switching point on the access road to the controlled-access highway.

12. The method of claim 11, wherein the information about the access road to the controlled-access highway includes at least one of inclination information of the access road, or tollgate position information on the access road.

13. The method of claim 12, wherein the determining of the switching point includes:
when each of a distance between an inclination start point on the access road and the controlled-access highway, and a distance between a tollgate point on the access road and the controlled-access highway is larger than a distance between the shortest point and the controlled-access highway, determining, as the switching point, one of the inclination start point and the tollgate point closer to the shortest point.

14. The method of claim 12, wherein the determining of the switching point includes:
when each of a distance between an inclination start point on the access road and the controlled-access highway, and a distance between a tollgate point on the access road and the controlled-access highway is smaller than a distance between the shortest point and the controlled-access highway, determining the shortest point as the switching point.

15. The method of claim 11, wherein the information about the access road to the controlled-access highway includes at least one of curvature information of the access road, or tollgate position information on the access road.

16. The method of claim 15, wherein the determining of the switching point includes:
when each of a distance between a curved-road ending point on the access road and the controlled-access highway, and a distance between a tollgate point on the access road and the controlled-access highway is larger than a distance between the shortest point and the controlled-access highway, determining, as the switching point, one of the curved-road ending point and the tollgate point closer to the shortest point.

17. The method of claim 15, wherein the determining of the switching point includes:
when each of a distance between a curved-road ending point on the access road and the controlled-access highway, and a distance between a tollgate point on the access road and the controlled-access highway is smaller than a distance between the shortest point and the controlled-access highway, determining the shortest point as the switching point.

18. The method of claim 10, further comprising displaying, by a display, information about the switching of the vehicle's driving mode to the sport mode.
